(19) United States
(12) Patent Application Publication
(10) Pub. No.: US 2006/0166720 A1
(43) Pub. Date: Jul. 27, 2006

(54) Universal wrist worn holder for cellular phones

(76) Inventor: Herman Dixon, Thornton, CO (US)

Correspondence Address: Herman Dixon, 2921 E. 78th Av., Thornton, CO, 80229, US

(21) Appl. No.: 11/254,285

(22) Filed: Oct. 19, 2005

Related U.S. Application Data
(60) Provisional application No. 60/620,206, filed on Oct. 19, 2004.

(51) Int. Cl. H04M 1/00

(52) U.S. Cl. 455/575.6

(57) ABSTRACT

A perspective view of the embodiment of a universal wrist worn holder of cellular phones and other small devices similar in size and shape. In this case (52) the phone is held atop a wristband's (20) top surface and across the band's (20) width, which is configured to be carried about a user's wrist. The band (20) being rectangular or ellipse having two outer ends length and two sides width has also when longitudinally open, (46) a running half way point-center. The half way point from one end to the far end dissecting the bands length. The band's width varying from two inch to three and five eight inch near center. From an over head view of the open band (20) with its far left end at nine o'clock, its far right end at three o'clock and its running halfway point dissecting the band's length ninty degrees at twelve o'clock to six o'clock, (46) the center line. Two flexible materials are folded to form two L shaped strips. The L shaped holding members, which has each an upper portion (26A) the left leg and (28A) the right leg which stands ninety degrees up from the bands top surface with (26B) the left and (28B) right lower foot portions, which lay attached to and across the band's top surface apart and parallel to one another at the desired distance to the right and left of where (46) the center line dissect the bands length.

These leg holders are the flexible materials which holds the object to be carried in place atop the band, in this case (52) a cellular phone. Each leg holder has attached to its inner wall toward center a strip of hook and loop material (30A) left, and (30B) right, matching both leg's height and width. Additional, (32A) left and (32B) right, two matching mating hook and loop fastener strips are bonded to the outer sides of (52) the cellular phone, then mates to (30A and 30B) the inner leg hook and loop fastener strips when the phone is placed between the legs. Thereby securing (52) the phone to both the leg holders and (20) the band. The band (20) have attached to its far left end's top surface at nine o'clock, (22A) a patch of hook and loop fastener across the bands width, extending inwardly toward the opposite end to a point adjacent (36B) the left foot (24A), the left hook and loop fastener stitch line placement Having also, (22B) a matching, mating patch of hook and loop fastener attached to (20) the band's far right end under surface, also across the bands width, extending inward toward the opposite end to a point adjacent (28B) the right foot, at (24B) the right hook and loop fastener stitch line. When the band encircles the wrist and the end patches overlap one another, the band secures to the user's wrist. The material used in constructing this band and its holding members are attached together by sewing, gluing, glue press, hot press, and other bonding means. The materials most suitable in the present use are. Leather, vinyl, and other materials such as heavy woven plastics, naugerhide, nylon, rayon, combined chain band and soft flexible plastics like those nick named jellies, plus many other manufactured relatively durable, flexible band and strap used sporting, fishing and hunting fabrics on the market to day, plus rigid materials used for bracelets such as, but not limited to, gold, stainless steel, silver and chain linked rigids like wood, plastic and woven chain.

### CROSS REFERENCE TO RELATED APPLICATIONS

Not applicable

### BACKGROUND

1. Field of Invention

This invention relates to universal wrist worn holders of small devices in particularly cellular phones.

2. Discription of Prior Art

There are many holders, Carriers, jacket covers, and assemblies on the market for holding and carrying small electrical and non-electronic devices to day and they serve their purpose allthou not always very well. The desire today is to use today's technology with as little effort as possible, as versatile as possible, as small as possible, as handily as possible or as on hand as possible, such as with cellular phones needed, all day, every day, and every minute of the day. Efforts have been made and are being made to solve these accessibility problems, but so far few combination of solutions have been mixed. The public needs hands free cellular phone capability, especially when jogging, working, biking, doing house work and especially while driving. U.S. Pat. No. 4,135,653 Sieloff 1979 shows an arm band assembly for carrying a portable radio. This band is covered with straps, loops and snaps making it incompatible with electronics devices of to day. U.S. Pat. No. D253, 939 to Montgomery 1980 shows a wrist band mount tape measure that snaps to the band, making it hard to use on a job due to the fact that one must visually reengage the tape between movements. Making it time consuming, bothersome and one-dimensional. U.S. Pat. No. D 347,589 to LaBate 1994 a wrist band and mounting for a tape measure, shows a band with another smaller band split with snaps for surrounding a tape. This configuration leaves the tape more accessibly removed and returned while in use but is incompatible with cellular phones and most other small devices especially electronic. Pat. No. D 358,553 to Murakami in 1995 is a wrist watch radio-telephone. This is a combined device and holder made as a unit not as a separate universal holder. U.S. Pat. No. 6,478,205 (2002) to Fujihashi shows a portable telephone set holder is comprised of a portable telephone set housing section extending from the housing and a suspending section provided on a rear surface of the housing. This relates to conventional cellular phone holders of phone jackets and cases not carried on the wrist. U.S. Pat No. D 256,292 (1980) to Cox shows a wrist band penholder. This band has a fixed pen holding housing which is capable of holding the like only and is of watchband design and limited there to. U.S. Pat. No. 1,689,396 (1928) to Lag shows a cylindrical rectangle case, a water proof bathing case with a strap type band having a closeable one end secured by snaps. It is able to hold soaps cigarettes and the like but inaccessible for modern devices particularly electronic devices and those repeatedly used or removed from the holder. U.S. Pat. No. D 372,878 (1996) to Finnegan a workman's magnetic wrist band for holding small metal objects is shown. A band capable of holding nails and the like but the magnet is not powerful enough to hold larger things.

U.S. Pat. No. 1,407,239 (1922) to Weiss shows a wrist tablet, which sits atop a watch type band, having the wider tablet secured there to. Having also a writing means held by two loops secured to the tablet. This invention is a one-dimensional holder, essentially a single non-versatile unit. U.S. Pat. No. 4,069,954 (1978) to Rauch shows a golfer's wrist band for carrying tees and ball position markers. This band shows a wide band with longitudinal extendable fabric, with strips of hooked pile fabric to secure it to the wrist. It is provided with web to form loops to hold golf tees and balls position markers with the marker disc confined beneath the tapes and the marker studs projecting between the tapes. This band is a single one-dimensional unit and can only be useful as a golf accessory holder. U.S. Pat. No. 6,173,451 (2001) to DeVincenzi shows another wrist band for carrying golf tees, ball position markers and divot tool. This band is also a one-dimensional unit without further uses. U.S. Pat. No. 2,602,573 (1952) to Herbs shows a watchband with two holding loops which holds a watch in the conventional manner. That is, the holders are loops and are used with the small rod which inserts through the holder to the watch holding means. This band can not hold without the through pin and is for watch size objects. U.S. Pat No. D 317,730 (1991) to Mo shows a combined holder with arm band shows a ornamental design for a combined magnetic holder with arm band having a magnet buckle type across center having fastening attachments at each end. This holder is another very limited holder. It has no sides and is unable to hold side motion weight U.S. Pat. No. (1983) to Cox shows another wrist penholder where Cox uses a flexible material band, with an arrangement atop the band's top surface, configured to loop over a pen before and after center with a stitch line at and along center, separating the two pens. These holders can only accommodate pen shapes and are unable to hold other forms. U.S. Pat. No. 4,425,600 (1984) to Barnhart shows an Electro-luminescent wrist lamp for night vision environment which is a bulky light assembly atop a watch band. Illumination is the band's limitation. U.S. Pat. No. 3,112,889 (1963) to Etal shows a wrist supported flash light mounted atop a watch type band having a buckle to secure it to a wrist. This arrangement leaves the light able to be easily snagged apart from the band. U.S. Pat No. D 344,628 (1994) to Taggart shows a wrist pad having a writing pad mounted atop a band extending across the band's width and although it may be handy it is one-dimensional. U.S. Pat. No. 2,400,222 (1946) to Cline shows a wrist purse constructed of flexible material. It has a band with two bands attached to its top which loops through a watch's holding arms across center with a zipper purse on its opposite inside wall and a buckle at its end to hold it about a wrist. This configuration allows the band to hold and carry only those devices with has watch holding arms attached to them. U.S. Pat. No. D 399,605 (1998) to Metcalf showing a wrist band mounted container for lip balm having a watch like band with a box type container attached at its top surface. This arrangement is combumsm, bulky and easily snagged while in use. The band being to narrow allows the big top portion to flop and twist off if pulled at, and over time will cause abrasions about the wrist Prior Art not found in PTO but on Web is on addendum pg. 03.

### SUMMARY

In accordance with the present invention a universal wrist band holder comprising two flexible L shaped materials—holding members both with an upper portion the leg, both legs has attached to its inner wall toward center, a Hook and Loop fastener, here after called H&L strip, with two separate mating H&L strip each. Both legs has a lower foot whish attaches to and across a wristband, one on each side of center. The two separate mating H&L strips bonds to the out sides of the phone, then mate to the leg H&L strips.

The phone secures to the band, which has two H&L patches one on each outer end, securing the band to the wrist as the two end H&L patches overlap one to another. Thus, a universal wrist band holder of cellular phones and other devices similar in size and shape.

### OBJECTS AND ADVANTAGES

Accordingly, besides objects and advantages of the universal holder described in my above patent, several objects and advantages of the present invention are:

(a) to provide an improved universal holder for cellular phones and other small devices similar in size and shape.

(b) To provide a holder which would offer easy carrying ability.

(c) To provide easy device loading and unloading atop the band and provide a holder which would place the cellular phone and other operable electrical devices in easy hand reach.

(d) To allow close visual and readable range for such devices and bring conventional ear-phone cords up one's sleeve to the ear.

(e) To allow upright or upside down insertion and operation of the phone or device held.

(f) To allow for a radio, calculator, electrical address or phone to be dialed when having the band hand on the top part of an auto steering wheel when driving while same time still be able to clearly see the road.

(g) To provide a holder that can hide a phone, a child protection beeper or voice device in emergencies up one's sleeve when one deems it necessary.

(h) To enable one to jog while communicating over the phone and not loose the phone by knocking it off a belt with an arm swing or bouncing it from a pocket.

(i) To prevent one searching through items in the car seat when driving and the phone rings.

(j) To prevent leaving one's phone at a friends or strangers.

(k) To solve the entanglement problem with one's coat, phone hooks, clamps, phone cases and jacket holders while sitting or reaching for the phone.

(l) To hold and carry multiple devices such as the aforementioned and those of FIG. 54 through 54-8, designed and invented as essential parts of the present invention.

Further objects and advantages are to provide a holder which is simple and non complex to produce in any color materials, such as leather, vinyl, nylon, canvas type fabric, soft pliable plastics, and many mesh type sports, hunting and fishing band and strap plastic materials used to day, which can be worn on either wrist, arm, leg or any where one places a small mating patch of H&L with ease of use, and on the lower leg with out pins, buckles or snaps to hold the phone in place.

Still more object and advantages will be apparent after viewing and understanding the description and accompanying drawings.

### BACKGROUND

1. Field of Invention

This invention relates to universal wrist worn holders of small devices in particular cell phones.

2. Discription of Prior Art

After filing my PPA, I have located four photos of other Prior Art on the web and assembled them in 1. The Sports Cell Holder as seen on Uncommon Goods home page with no further information.

FIG. 1 shows a photo of the Sports Cell Holder having an elastic sock top type wrap (sock ankle portion without the foot). An elastic tube six to ten inches long. Sewn to one side of the sock Apr one inch from one end is a small pocket with its open one end pointing inward toward the remaining longer material side.

Configured to create an elastic pocket of conventional cell phone width and half the normal cell phone length. When a phone is inserted into the pocket half the phone is exposed. This allows one to see the dialing portion and a little of the viewing area. This holder will hold a phone under normal circumstances but when in active situations the phone will eject. With one end of the phone not secured it is free to pull out by movement or clothing. A punching motion can slide the phone out whether the tube is worn upside down or down side up. The sock, tube, or tight fitting band extends half the distance from the hand to the elbo, making it ugly, sweaty, and all the uncomfort that comes with a cast. With some smooth slick metallic phones the raising of the arm will drop the phone.

FIG. 2 shows a Wrist Band Case for Nokia—Cellphone Shop—RedTag Stores.com. No patent imfo. Shown is a cell phone size holster, which encompasses two thirds of a phone when the phone is inserted into the holster, leaving the one third to protrude above the one open end like a gun from a holster. The holster is constructed in the same manner as a snub nose gun holster, complete with the strap over the but of a gun. This strap wraps from the back or holster against the arm over the open end of the holster and over the exposed one-third portion of the phone. The holster has a wrist band which attaches along the back of the open area of the holster leaving the remaining holster to hang down onto the hand as a gun holster does down the leg of a person. This is a good phone protector but forces one to place the wristband half way up the arm above the wrist to keep the phone from dangling on top of the hand. With the strap over the phone and so much of the phone inserted in to the holster the phone has to be removed to see or operate it. The narrow band will have to be blood stopping tight to prevent the bend from sliding down around the wrist where it normally should be and the phone then will be like a small animal loosely clinging, flopping and swinging back and forth.

FIG. 3 Shows the Csleeve. Patent Pending—http://www.csleeve.com/. This add shows a woven material arm band which extends from the wrist partway up the forearm Apr nine to ten inches and fasten about the arm by H&L fasteners. It has a pouch for housing an ear phone cord. An oval shape stretchable materials with a oval cutaway top center area is designed to allow access to most of the dialing and viewing area of a cell phone when the materials are sewn on the top of the band across the band's width creating a stretchable pouch. The oval shaped pouch when attached atop the arm band can be stretched over a phone and will hold a phone well although the stretchy material will allow the phone to slip and twist in its pouch and during activity it may slide out. Due to this the cutaway material partly covers the viewing and dialing area. This armband covers a large part of the arm and appears deformed, saucer like and will exhibit the same uncomfortable traits as the Sports Cell Holder FIG. 1.

FIG. 4 JAMinnouation http://wwwjaminnov.com/producthtml-Hold a Phone, shows three cell phone holder versions, one of which is not relevant and one is a wrist holder having a band longer on end and a large out set across center with the other far end shorter. To the out sets on each side across center and the band's width is an elastic fabric stretched and fitted across and around each end for encircling and overlapping the phone's each end, securing the phone to the band. The last version is relevant as the band is shaped like one of my invented versions, but there is where the relevancy ends.

The last version is relevant as it is shaped like a version of my invention where the wide band starting from the band's each outer far end and tapers in to center on each side.

This holder is made for flip open phones and has attached on each outer side at its widest across center a strip of elastic material stretched at a right angle to the band's width across the centerline.

This strap is to be stretched overlapping an open cellphone body inside at and parallel to the hinge line of the top. This will hold that side of the band and the phone together. The opposite side has also an elastic strap to stretch over the inside face of the phone to hold the phone to the band when the phone is open.

This strap is then placed across the outside body when the phone is closed, to hold the phone to the band when the phone is closed.

The Hold a Phone is a neater looking holder than the Sports Cell Holder, Wrist Band Case, and the CSleeve but the strap version is a shabby construction and will not hold the phone safely in most normal situations. The strap being stretchable will not only stretch when you want it to, but when you don't want it to. When opening the phone top with a call coming in the act of switching the elastic from the outside to the in side will be bothersome and slow or one will pull it apart. All of the afore mentioned holders are capable of holding other devices but due to their construction one will not be able to use them if the device has dials that are not in the center of the device. Devices like Compaq kits, makeup kits, tool kits, paint brush holders, compact flash lights, pagers, and many other devices similar in size and shape because most will not be allow to open due to the construction of the Prior Art found in my searches.

My Universal Holder will carry all the devices mentioned and hundreds of others not mentioned or thought of. My universal holder having the L shaped holding members will because of its design, hold and carry any thing similar in size and shape as a cell phone with the ability to open and use such devices not to exclude those that do not open.

### DRAWINGS FIGURES

FIG. 1 is a perspective view of the embodiment of a wristband as a universal holder in closed configuration as if about a users wrist.

FIG. 2 is a perspective view of the open one-piece wristband with a left and right L shaped holding member—the legs, hovering in line above the band, to the left and right of the imaginary center line across the band width.

FIG. 3 is a top, front and left side perspective view of the wristband with the left side leg in line above the band. Above this leg is the Hook and Loop fastener strip which attaches to the left leg's inner wall and the leg has a lower foot portion. Above the hovering right leg is, a ghost of the H&L strip which attaches to the right leg's inner wall.

FIG. 4 shows the left end H&L patch hovering in line above the band showing the H&L stitch line placement while the left leg and it's foot and right leg and it's foot are attached in place across the band. The stitch line placement of the right end H&L patch is shown, with the right end H&L patch suspended in place below the band's right end.

FIG. 5 shows the band with the left and right end H&L patches in place while showing the left and right legs with their inner wall H&L strip attached in place and a mating left and right H&L strip in line above, while showing also the leg's foot portions attached in place across the band's width.

FIG. 6 is a top, front and left side perspective view of the band having all aforementioned parts attached in their perspective places, with the addition of the object to be held and carried in position across the band.

FIG. 7 is a side view of the open band with from left to right, the left end H&L patch, the left H&L stitch line placement, the left leg and foot and its inner wall Velcro strip followed by its mating H&L strip.

To the right of center is the right side mating H&L strip adjacent the right side leg inner wall strip attached to the right leg with it's foot adjacent the right H&L stitch line showing the right end H&L patch attached to the right end's under surface.

FIG. 8 is a perspective view of the band comprising all parts described, in FIG. 1 through 8. FIG. 9 is FIG. 1.

FIG. 10A is a universal narrow three-piece band from a raised left and side perspective view constructed in accordance with the invention showing two bands, a bottom base band and a top band which is cut 90% along the center line across the band's width making three pieces and the top two inner ends toward center are sewn short of the center line left and right, at the upper leg stitch-line across the band's width.

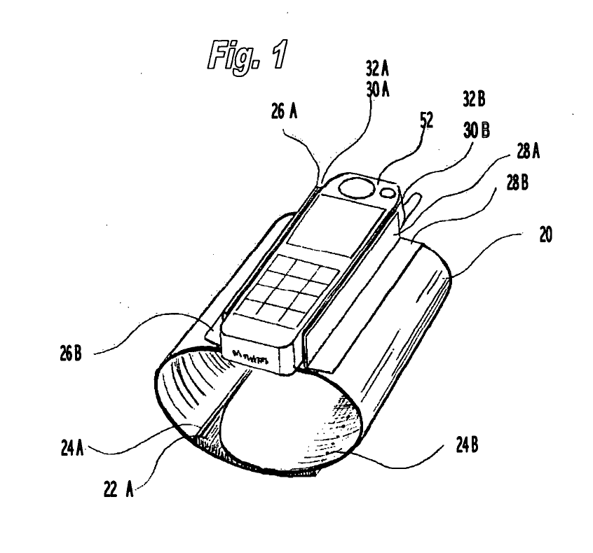

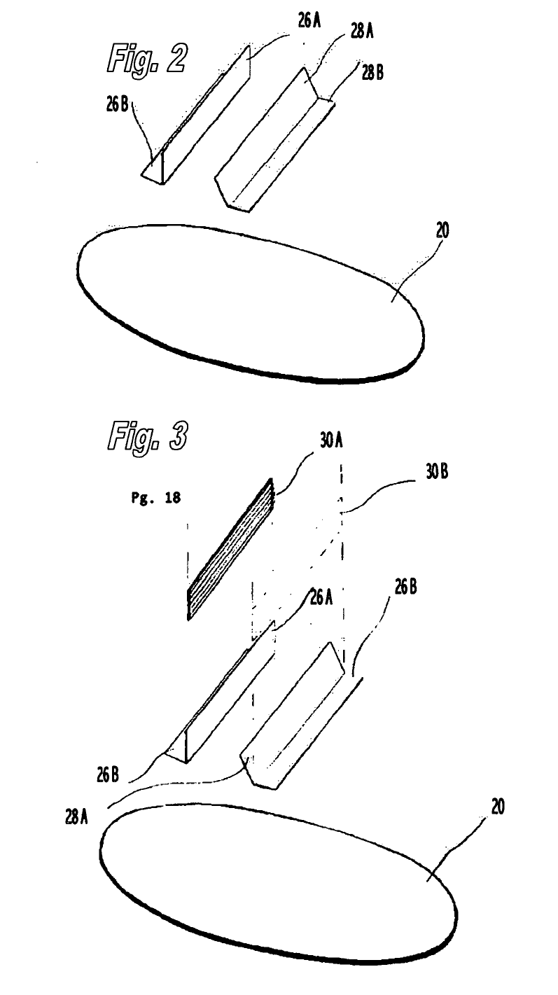

The remaining material toward center, the short flaps, are raise ninety degrees up from the bottom full-length base band's top surface. These inner ends left and right are the upper portion or legs of the Long foot L shaped holding members, leaving two lower long foot portions which extend from the stitch line short of center to the outer ends of both bands. Shown also is an example of an alternative device to be held and how it fits in place between the two legs. The outer ends of the bands are faded out to focus attention to the inner ends operation atop the base band, the long foot is just an extended short holding members foot of FIGS. 1 to 8.

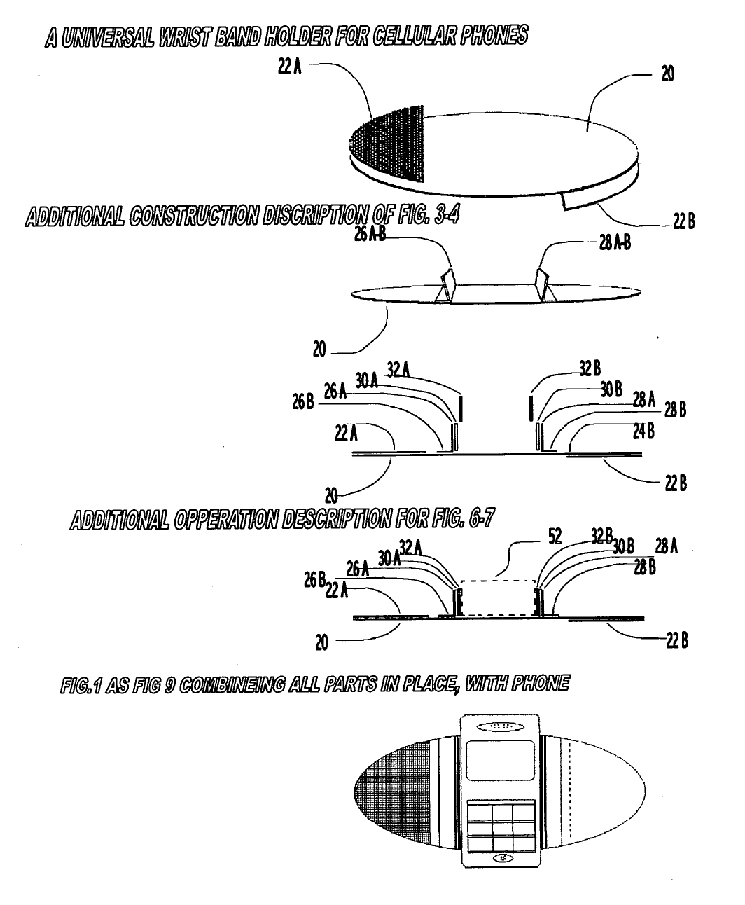

FIG. 10B is a tilt, left and side perspective view of FIG. 10A the universal narrow three piece band, showing a clear left end view of how the long foot lay attached atop the base band. A H&L patch is shown attached to and across the band's top left end while moving inward, the left leg stitch line is shown as the left leg raises ninty degree up, short of the imaginary center line. To the right of center is seen the right side leg H&L strip attached to the inner wall of the right side leg. The right side long foot is seen angling to the right atop the base band with its end H&L patch hovering above. Seen also is two examples of small devices similar in size and shape as cellular phones. To the right of FIG. 10B is a demonstration as to how bigger phones sit atop the narrow band, with a blacked out view of a block type device held, in this case a makeup and compact kit.

FIG. 11 is a side view of the band FIG. 10A. 10B FIG. 12 and FIG. 13 having from left to right, the left end H&L patch and left H&L stitch line placement plus the leg stitch line short of center. The left leg and long foot is shown followed by the left leg H&L strip and its mating H&L strip short of center. Short of center to the right is the right mating strip near its right leg strip and the right leg with it's long foot in place.

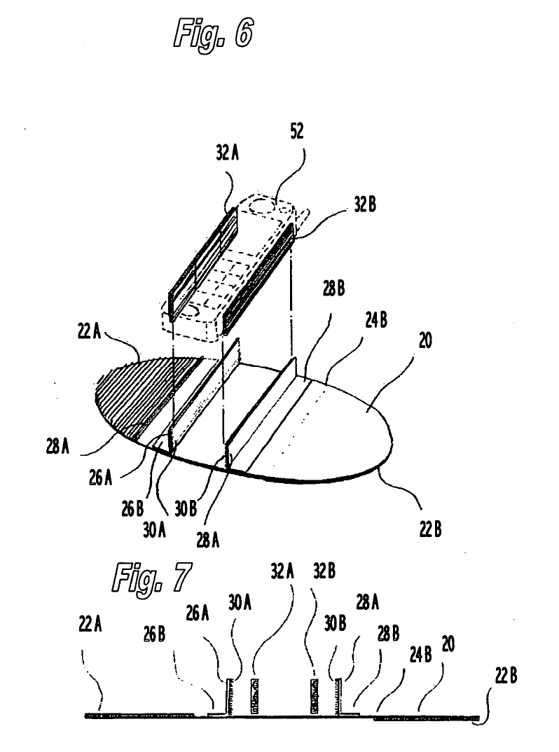

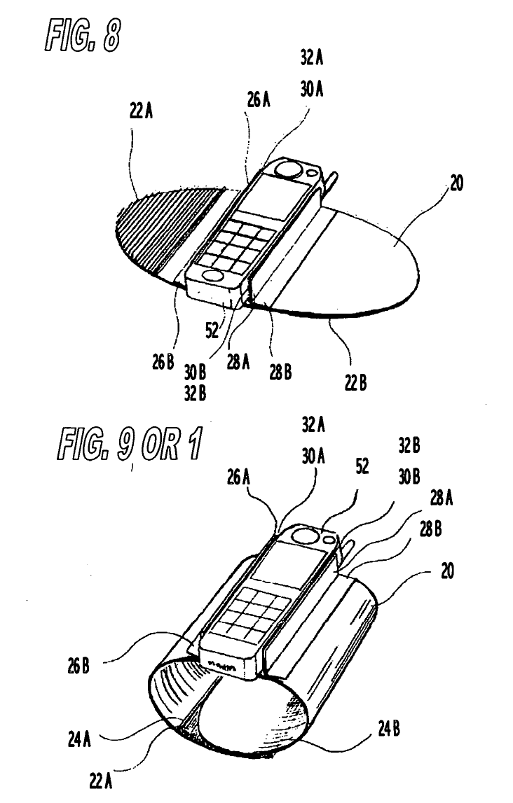

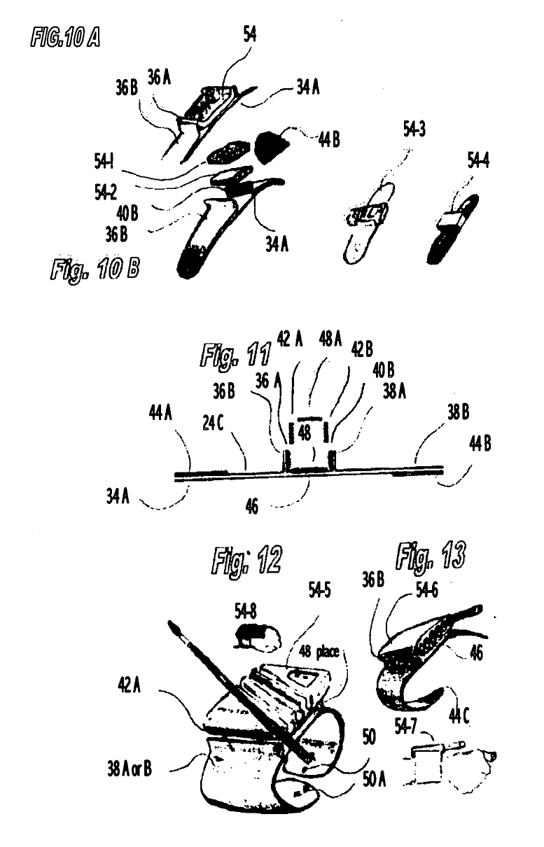

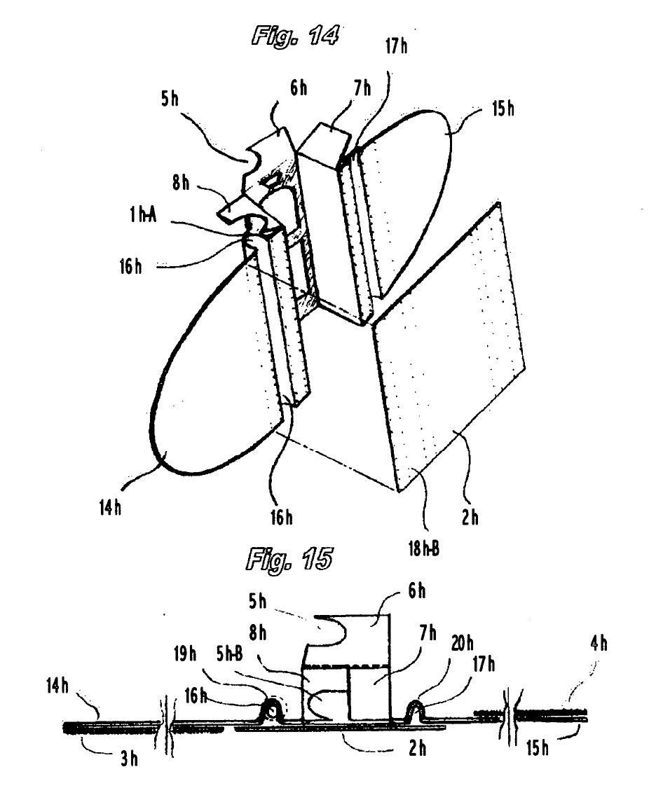

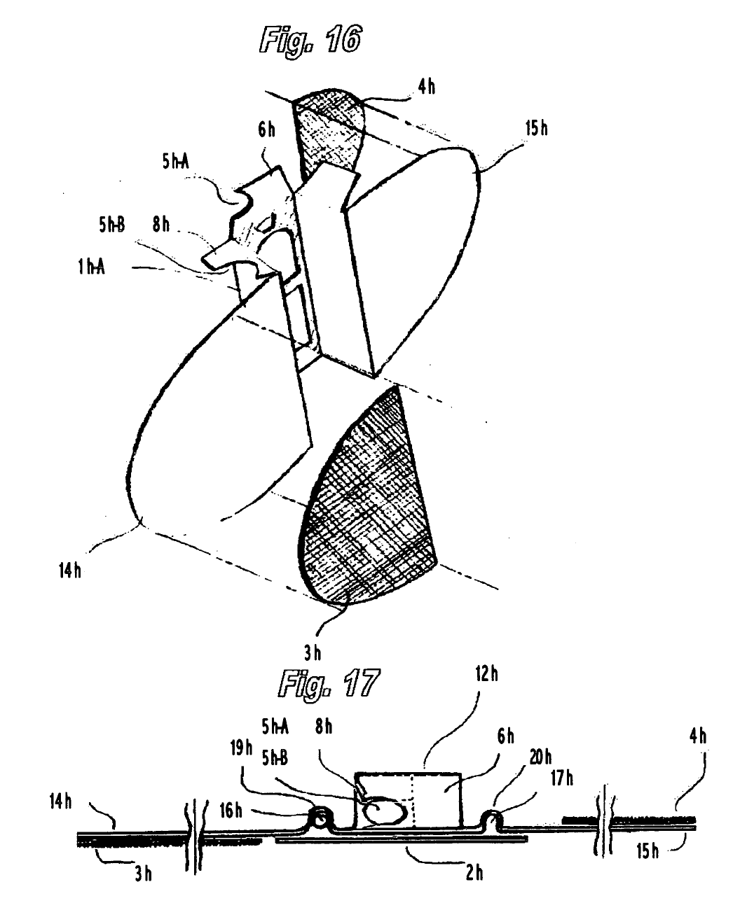

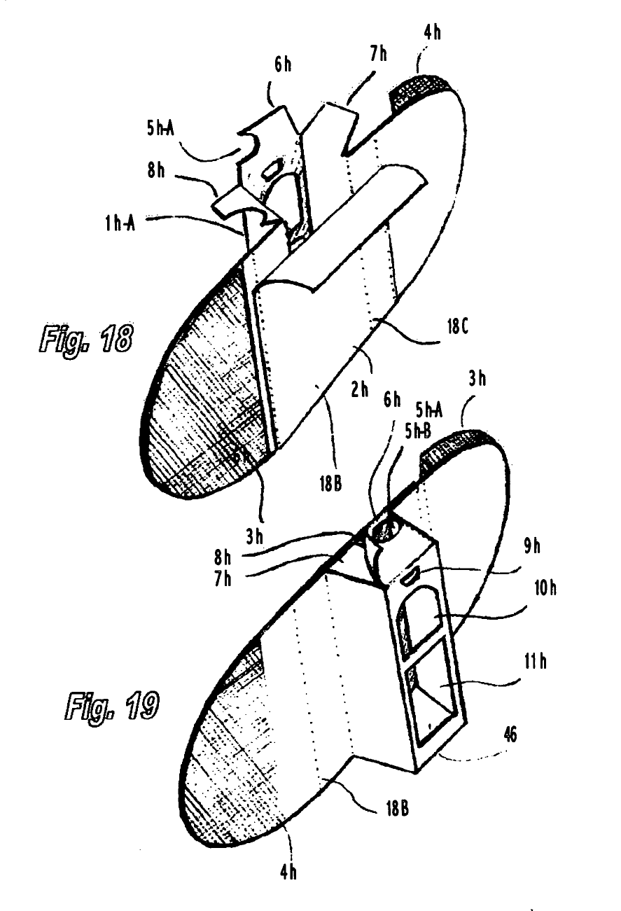

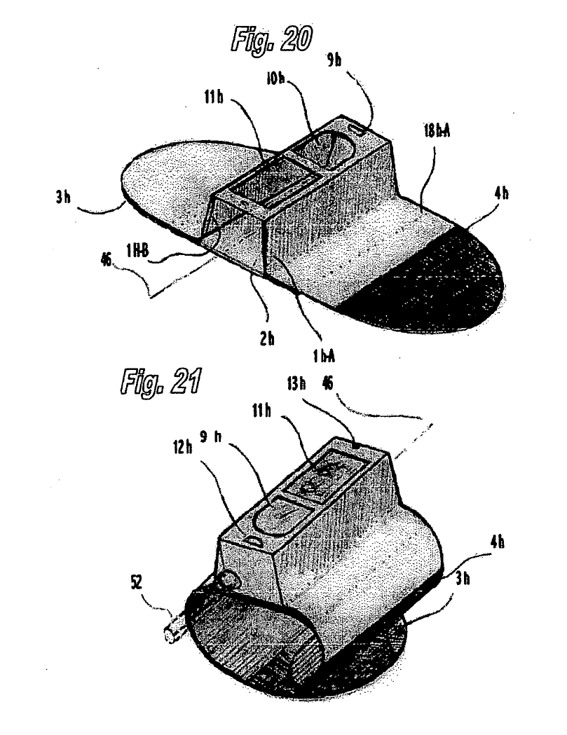

The right H&L stitch line placement is shown while the right end H&L patch lay in place below the band's end. FIG. 54-5 is a device to be held with FIG. 54-8 another example.

FIG. 12 another version of the universal holder is shown, having a wide band as the wide band of FIG. 2 this time using the long foot L shaped holding member of FIGS. 10 and 11. This version is also two-bands with the top band dissected at and along center as in FIG. 10 the three piece band. The band's construction mirrors that of FIG. 10. The end H&L patches are not shown to allow for clear understanding the conventional end lock snaps, male and female or vice versa, which are located along a vertical horizontal center along the band's length from its outer ends and are possible for all versions. The snaps are placed evenly apart as they must align one to another. The snaps are placed on top and or through the end H&L patches. Conventional and not a claimed part of my invention.

FIG. 13 is the wide narrow band where as the band starts narrow at its outer ends tapering out to a wide band near center, showing the left H&L strip mating to the mating strips bonded to the phone. The left end narrow H&L patch seen here, as the right end angling away not showing the right end H&L patch. This version is fitted with a cross center H&L pad as in FIG. 11 between the legs and a mating pad bonds to the under surface of the phone. Shown atop the band demonstrates, where the mating H&L strips bond to the phone or device's outer sides and to the upper leg strips. FIG. 54-7 shows the band about a wrist and another example as to the positioning of the devices held.

### REFERENCE NUMERALS IN DRAWINGS

(1) 20 band
(2) 22A left H&L patch
(3) 22B right H&L patch
(4) 24A left H&L stitch line placement
(5) 24B right H&L stitch line
(6) 24C FIG. 11 Left H&L stitch line pl.
(7) 24D FIG. 11Right H&L stitch pl.
(8) 24E left leg stitch line
(9) 24F right leg stitch line
(10) 26A left leg
(11) 26B right foot
(12) 28A right leg
(13) 28B right foot
(14) 30A left leg H&L strip
(15) 30B right leg H&L strip
(16) 32A left mating H&L strip
(17) 32B right mating H&L strip
(18) 34 band
(19) 36A FIG. 11, left leg
(20) 36B FIG. 11, left foot
(21) 38A FIG. 11, right leg
(22) 38B FIG. 11, right leg foot
(23) 40A left leg H&L strip
(24) 40B right leg H&L strip
(25) 42A left mating H&L strip
(26) 42B right mating H&L strip
(27) 44A left end H&L patch
(28) 44B right end H&L patch
(29) 44C FIG. 13 left end H&L patch
(30) 44D FIG. 13 right end H&L patch
(31) 46 twelve o'clock to six o'clock-center
(32) 48A cross center H&L pad
(33) 48B mating cross-center pad
(34) 50A male snaps
(35) 50B female snaps
(37) 52 cellular phone

### Device examples constructed for use with this invention

54 - socket block
54 - 1 magnetic socket block
54 - 2 three lens flashlight
54 - 3 example with 52
54 - 4 block device-compact etc.
54 - 5 brush, pen block with clock
54 - 6 pen, pencil, cigarette, drill block
54 - 7, 8 position example

Additional embodiments of the universal wrist band holder of cellular phones and other devices similar in size and shape are as follows.

FIG. 14 is a bottom and open one side perspective view of a long band, showing the long flexible band configured to a mold showing its structural form from the bottom and insides left to right. From the left end moving in ward toward center to a drill or pen holder rabbet configured in to the mid section of the band's left side material adjacent the leg wall which turns at a right angels up from the left end's material and across to the phone's face joining the right leg at center. Extending out from the leg is the left side flap open with the antenna cutout having above, extending out off the top, the cross center flap open with its matching antenna cutout which matches the left side antenna cutout when they both are closed, with the right side flap open and extending out off the right leg adjacent the right side flat end drill rabbet from which the band extends to its far right end. Shown exploded out in line below the band is the sweet pad showing the pad's left stitch line not numbered with the left rabbet's left stitch-line numbered and the left rabbit's right stitch-line is not numbered along with the left leg, the right leg, the inside right rabbet stitch-line, the out side right side rabbet stitch-line and the right side sweet pad stitch-line all not numbered.

FIG. 15 is a side perspective view of the band with from left to right The band's left side drill rabbet, the left leg, the left side flap and the cross center flap, with the right flap, the leg, and the right flat end drill rabbet and the right far end. Below the left end is the left H&L patch and atop the far right end a mating H&L patch

FIG. 16 is a bottom and open side perspective view as in FIG. 14 with the absence of the sweet pad featuring, an exploded view of the left end Velcro patch and the right end H&L patch in line out from the band with the left leg, the left side flap and its antenna cutout. Then the cross center flap and its antenna cutout with the right side leg flap as in FIG. 14. The cellular phone face cover can be seen from its inside view and along with the right leg's inside wall inside the phone cavity. The band's ends are shown left and right and the band is a plain version without the drill or pen rabbets.

FIG. 17 is FIG. 15 with the exeption, the cross center flap is closed down covering the left and right flaps showing a smooth closed one end. The dotted lines show the left and right flap positioned behind the cross-center flap which is an extension off the top face cover portion of the band

FIG. 18 is FIGS. 14 and 16 showing the three flaps open and the left H&L patches attached, with the sweet pad partially attached and folded back at one end with the right H&L patch in line near the band's right end. The sweet pad stitch-line not numbered is shown and the rabbet left side stitch-line placement is shown numbered while the right side rabbet stitch-line is shown not numbered and the left leg stitch-line the right leg stitch line and the right rabbet stitch-line left and right are not numbered with the right sweet pad stitch-line shown also not numbered.

FIG. 19 is FIG. 18 reversed showing a top and one side perspective view of the band showing from the same closed end as in FIG. 17 having the left and right flaps closed and covered by the cross center flap which has a one corner folded back exposing a portion of the right flap beneath the cross center flap. With the flaps all closed one can observe the antenna through it's cutouts and the phone face cover as the top, plus an example of he phone's view screen and dialing cutout which are covered with clear material.

The speaker port is shown atop the face. A demonstration of the imaginary center line dissecting all the aforementioned band embodiments. Other wise the band is the same as in FIG. 18.

FIG. 20 is a top and one side open perspective view of the long band showing a one open end of the completely assembled band in open configuration as a bird in flight. Showing all parts attached in their places by sewing bonding with the preferred materials as those in the aforementioned Figs. featuring the running halfway point, center-line. The imaginary center-line.

FIG. 21 is FIG. 14 but is left in sequence to demonstrates the assembly progression and is FIG. 20 in closed configuration as if about a users wrist or limb and is shown with a ghost of a cellular phone within the phone cavity with the antenna protruding through the antenna cutouts showing the speaker port, view screen, the dial opening and mike port. The band's H&L patches, strips and positions can be reversed as desired.

### REFRENCES

1. (1h-A) left leg (1h-B) right leg
2. Sweet pad
3. LEFT H&L patch
4. Right H&L patch
5. 5 (h-A) antenna cutout 6h, 5 (h-B) antenna cutout 8h
6. Cross center flap
7. Right side flap
8. Left side flap
9. Speaker port
10. Phone view screen
11. Phone dialing cutout
12. Phone face portion
13. Mike port
14. Band's left end
15. Band's right end
16. (19) left drill or pen rabbet
17. (20) right drill or pen rabbet
18. (A) left sweet pad stitch-line (B) left side rabbet stitch-line
   (C) left inside rabbet stitch-line (D) left leg stitch-line
   (E) right leg stitch-line (F) right inside rabbet stitch-line
   (G) right side rabbet stitch-line
   (H) right sweet pad stitch-line

### DESCRIPTION

### 1 and 11 Preferred Embodiments

FIG. 1 is a perspective view of the embodiment of a one-piece wristband 20 as a universal holder in closed configuration as if about a users wrist

FIG. 2 is a perspective view of the open one-piece band with a left and right L shaped holding member which has a left leg 26A, and foot 26B and a right leg 28A, and foot 28B hovering in line above the band to the left and right of an imaginary running halfway point center 46 across the band's width.

FIG. 3 is a top, front and left side perspective view of band 20 with the left leg 26A, and foot 26B in line above the band. Above left leg 26A, is a H&L strip 30A H&L which attaches to the left leg's inner wall above lower foot portion 26B. Above right leg 28A is, a ghost of a H&L strip 32B which attaches to the right leg's inner wall above its lower foot portion 28B.

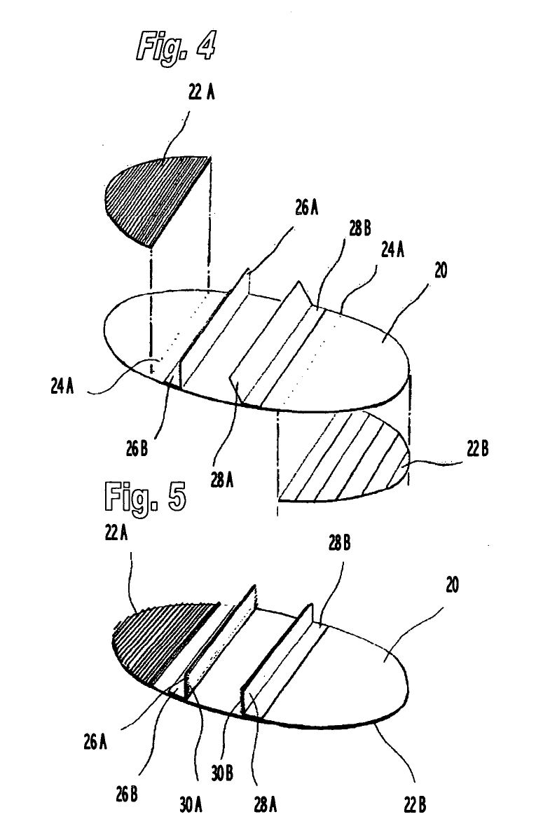

FIG. 4 shows a left side H&L patch 22A hovering in line above band 20 showing a H&L stitch line placement 24A while holders 26A, 26B-L and 28A, 28B-R are attached in place across the band.

The stitch line of the right end Velcro patch 24B is shown with right end H&L patch 22B suspended in place below the band's right end.

FIG. 5 shows band 20 where H&L patches 22A and 22B are in place while showing H&L strip 30A in place on left leg 26A and a H&L strip 30B in place on right leg 28A with their foot portions 26B and 28B attaches in place to the right and left of center across the band.

FIG. 6 is a top, front and left side perspective view of band 20 having all aforementioned parts in their perspective places, with the addition of a left and right mating H&L strip 32A, and 32B bonded to the outer sides of an object to be held, in this case a cellular phone 52.

FIG. 7 is a side view of the open band with from left to right, left end H&L patch 22A, left H&L stitch line placement 24A, left leg 26A, with its foot 26B, showing its leg inner wall H&L strip 30A, followed by a mating H&L strip 32A. To the right of center is a right side mating H&L strip 32B adjacent a right leg H&L strip 30B attached to right leg 28A with it's foot 28B adjacent a right H&L stitch line 24B, showing a right end H&L patch 22B attached to band's 20 right end under surface.

### 1-11 Preferred Embodiment

### References

FIG. 8 is a perspective view of band 20 comprising all parts described FIG. 1 through 8. FIG. 9 is FIG. 1

FIG. 10A is a universal narrow three-piece band 34 A. From a raised left and side perspective View constructed in accordance with the invention, showing one upper leg portion 36A as 38A inner wall toward center 46, is hidden. The band, is cut at and across the center line and sewn short of the center 46, at the leg stitch-line 24E, 24F across base band's 34A width. The remaining material toward center, the short flap are raise ninety degrees up from the bottom full-length base band's 34A top surface. These inner ends left and right are the upper legs of a Long foot L shaped holding members 36A,38A, having two lower long foot portion 36B-38B. Shown also is an example of an alternative device to be held 54 and how it fits in place between legs 36A-38A. The outer ends of the bands are faded out to focus attention to the top band's inner end 36A,38A and 36B,38B operation atop the base band.

FIG. 10B is a tilt, left and side perspective view of FIG. 10A the universal narrow three piece band 34A, showing a clear left end view of how long foot 36B,38B lay attached atop base band 34A.

A H&L patch 44A is shown attached to and across the top band's left end. Moving inward, the left leg stitch line 24E is shown as left leg 36A-raise ninty degree up, short of imaginary center line 46.

To the right of center is seen a right leg H&L strip 40B attached to the inner wall of right leg 38A. The right side long foot 38B is seen angling to the right atop the base band with its end H&L patch 44B hovering above. Seen also is two examples of small devices 54-1, 54-2 similar in size and shape as cellular phones 52. To the right of FIG. 10B is a demonstration as to how bigger phones 54-3 sit atop the narrow band, with a blacked out view of a block type device held 54-4, in this case a makeup and compact kit.

FIG. 11 is a side view of the band FIG. 10A 34A FIG. 10B 34B FIG. 12 34C and FIG. 13 having from left to right, left end H&L patch 44A, left H&L stitch line placement 24C and leg stitch line 24E short of center 46, left leg 36A and long foot 36B is shown followed by left leg H&L strip 40A and its mating strip 42A short of center. Short of center to the right is the right mating H&L strip 42B, near its right leg strip 40B, with right leg 38A at stitch line 24F and its long foot 38B in place.

The right H&L stitch line placement 24D is shown while right end H&L patch 44B lay in place below the band's end. FIG. 54-5 is a device to be held with FIG. 54-8 an example.

FIG. 12 another version of the universal holder is shown, having a wide band 34B as the wide band of FIG. 2. This time using the long foot L shaped holding member of FIG. 1A-B. This band is a base band with two top bands dissected at and across center as in FIG. 10 the three piece band. The band's construction mirrors that of FIG. 10. The end H&L patches are not shown to allow for clear understanding the (conventional) end lock snaps 50A male, and female 50B or vice versa, which are located along a vertical horizontal center along the band's length from its outer ends and available for all versions. The snaps are placed evenly apart as they must align one to another. The snaps are placed on top and or through the end H&L patches and are (Conventional.)

FIG. 13 is the wide narrow band 34C where as the band starts narrow at its outer ends tapering out to a wide band near center 46, showing a left H&L strip 40A mating to a mating strips 42A bonded to phone 52. The left end narrow Velcro patch 44C seen here, as the right end angling away not showing the right end H&L patch 44D. This version is fitted with a cross center H&L pad 48A as in FIG. 11 between the legs H&L strips and a mating pad 48B bonds to the under surface of phone 52 as in FIG. 11. Shown atop the band, 40A and 42A demonstrates, where the mating H&L strips bond to the phone or device's outer sides and to the upper leg strips. FIG. 54-7 shows the band about a wrist and another example as to the positioning of the devices held. OPERATION and use is the same as in page 34 of FIGS. 1 through 8.

### REFERENCE—NUMBERS

20 band
22A left H&L patch
22B right H&L patch
26A left leg stitch line
26B left foot
28A right leg
28B right foot
24A left H&L stitch line placement
24B right stitch line
24C FIG. 11 left H&L stitch line P1
24E left leg stitch line
24F right leg stitch line
26B left foot 28A right leg
28B right foot 30A left leg H&L strip
30B right leg H&L strip
32A left mating H&L strip
32B right mating H&L strip
34 band
34A FIG. 11, left leg
26B FIG. 1 left foot
38A FIG. 11, right leg
38B FIG. 11 right foot
40A left leg H&L strip
40B right leg H&L strip
42A left mating H&L strip
40C FIG. 13 Left end H&L patch
40D right mating H&L strip
46 twelve o'clock to six o'clock—center
48A mating cross center pad
48B cross center H&L pad
50 male snaps

### Device Examples for Use in My invention

54 socket block
54-1 magnetic socket block
54-2 three lens flashlight
54-3 large phone example of 52
54-4 block device, compque
54-5 brush and pen block example with clock
54-6 pen, drill, cigarette block example
54-7-8 position or fit example
50B female snaps
52 cellular phone

### ADDITIONAL-ALTRUNATIVE-EMBODIMENTS DESCRIPTION WITH FIG-REFERENCES

FIG. 14 is another embodiment from a bottom and open one side perspective view of a long band, showing the long flexible band configured to a mold showing its structural form from the bottom and in-sides. From left to right, the left end (14h) moving in ward to a drill or pen holder rabbet (16h, 19h) configured in to the band's material adjacent leg wall (1HA) at a right angels up from left end (14h). Extending out from leg (14h) is left side flap (8h) open with antenna cutout (5h-B), having above extending out off the top, a cross center flap (6h) open with its matching antenna cutout (5h-A) which matches (5hB) when closed, a right side flap (7h) open and extending out off a right leg (1h-B) adjacent a flat end drill rabbet (17h,20) from which the band extends to its far right end (15h). Shown exploded out in line below the band's ends (14k, 15h) is (2h) a sweet pad (2h) showing the pad's stitch line (18h-A) unnumbered with left rabbet stitch-line (18h-B) numbered, while left inside rabbet stitch-line (18h-C) is unnumbered along with left leg (18h-D), right leg (18h-E), the inside right rabbet stitch-line (18h-F), right side rabbet stitch-line (18h-G) and right side sweet pad stitch-line (18h-H). FIG. 15 is a side perspective view of the band with from left to right. Shows the band's left end (14h) and drill rabbet (16h-19), left leg (1A), left side flap (8h) and cross center flap (6h), with the right flap (7h), right leg (1h-B), and right flat end drill rabbet (17-20) on right mid end (15h). Below left end (14h) is left H&L patch (3h) and atop far right end (15h) is a mating H&L patch (4h).

FIG. 16 is a bottom and open side perspective view as in FIG. 14 with the absence of the sweet pad (2h), featuring, an exploded view of left end H&L patch (3h) and right end H&L patch (4h) in line out from the band with left leg (1h-A), left side flap (8h) and its antenna cutout (5h-B). Then the cross center flap (6h) and its antenna cutout (5h-A) with right side leg flap (7h) as in FIG. 14. The cellular phone face cover (12h) can be seen from its inside view and along with the right leg's (1h-B) wall inside the phone (52) cavity. The band's ends (14h) left and (15h) right are showing this is a plain version without the above drill or pen rabbets

FIG. 17 is FIG. 15 with the exeption of the cross center flap (6h) is closed down covering (7h) and (8h) showing a smooth closed one end. The dotted lines show (7h) and (8h) positioned behind (6h), also showing the band's top (12h) as the cellular phone (52) face cover location.

FIG. 18 is FIGS. 14 and 16 showing three flaps (6h, 7h, and 8h) open and left H&L patch (3h) attached, with the sweet pad (2h) partially attached and folded back at one end with right H&L patch (4h) in line near the band's right end (15h). The sweet pad stitch-line (18h-A) un-numbered is shown and the rabbet left side stitch-line placement (18h-B) is shown numbered while right side rabbet stitch-line (18h-C) is shown un-numbered and left leg stitch-line (18h-D), right leg stitch line (18h-E) and the right rabbet stitch-line left and inside (18h-F), and (18h-G) are un-numbered while the right sweet pad stitch-line (18h-H) is shown also un-numbered.

FIG. 19 is FIG. 18 reversed showing a top and one side perspective view of (14h, 12h and 15h) the band showing from the same closed end as in FIG. 17 having (8h right-7h left) the outside flaps closed and covered by cross center flap (6h) which has a one corner folded back exposing the portion of (7, 8h) beneath (6h). With the flaps all closed one can observe the antenna through cutouts (5h-A,(5h-B) and the phone face cover and top (12h), and too one sees a example of the phone's view screen (10h) and dialing cutout (11h) which are covered with clear (Conventional) see through material. The speaker port (9h) is shown atop the face (12h). A demonstration of the imaginary center line (46) dissecting all the aforementioned band embodiments. Other wise the band is the same as in FIG. 18.

FIG. 20 is a top and one side open perspective view of the long band (14h, 12h, and 15h) showing a one open end of the completely assembled band in open configuration as a bird in flight. Showing all parts in FIG. 14 to 21 attached in places as in FIGS. 1-13 with the same materials and showing the imaginary center-line.

FIG. 21 is FIG. 1 but is left in sequence to demonstrates the assembly progression and is FIG. 20 in closed configuration as if about a users wrist or limb and is shown with a ghost of a cellular phone within the phone cavity with the antenna protruding through the antenna cutouts (5h-A) and (5h-B) showing the Speaker port (9h), view screen, (10h) the dial opening (11h) and mike port (16h).

### REFRENCES

1. (1h-A) left leg (1h-B) right leg
2. Sweet pad
3. LEFT H&L patch
4. Right H&L patch
5. 5 (h-A) antenna cutout 6h, 5 (h-B) antenna cutout 8h
6. Cross center flap
7. Right side flap
8. Left side flap
9. Speaker port
10. Phone view screen
11. Phone dialing cutout
12. Phone face portion
13. Mie port
14. Band's left end
15. Band's right end
16. (19) left drill or pen rabbet
17. (20) right drill or pen rabbet
18. (A) left sweet pad stitch-line (B) left side rabbet stitch-line
   (C) left inside rabbet stitch-line (D) left leg stitch-line
   (E) right leg stitch-line (F) right inside rabbet stitch-line
   (G) right side rabbet stitch-line
   (H) right sweet pad stitch-line
      FIG. 10A-13—Additional Embodiments—Drawings

FIG. 10A is an example showing the upright legs and their relationship to the narrow band atop the base band and an example of an alternative device positioning. Additional embodiments are shown in FIGS. 10B, 11, and 12 where FIG. 10 demonstrated the narrow version of the three piece band with a base band and an identical top band which is placed evenly on top of the base. The top band is dissected at and across its running halfway point-centerline 46 across the band and is sewn across the band at a predetermined point right and left, short of 46 at the leg stitch-line, leaving a pair of loose ends-holding members which are folded ninety degree up to an L shape. Thus, the Long foot L shaped holding members, both having a leg as in FIG. 1 to 9 which stands at a right angle up from the base band's top surface and a long foot, unlike the aforementioned short foot of FIG. 1 to 8. The left long foot is sewn or bonded to the base from its far left end inward to the leg stitch-line, the point short of the center-line 46. This procedure is repeated in revere to the right of the imaginary center-line, mirroring the left long foot positioning, with the right long foot atop the base band's right end. The inside leg H&L strips are shown in FIGS. 3, 5, and 7 and are used accordingly with one exeption, they are a fraction shorter in width, and the leg mating H&L strips are seen in FIGS. 6 and 7 and are shorter also and used accordingly. The end H&L patches are shown in FIG. 4, they to are shorter and used accordingly.

FIG. 11 shows from left to right a horizontally open base band having attached to its top surface at its far left end, a left top band, which extends inward to the leg stitch-line at the raised left leg where to the leg's inner wall is the left leg H&L strip with its mating H&L strip in line above. Next, the cross center H&L pad is shown in place atop the base band and across center 46 with the mating cross-center H&L pad hovering in line above and across center. To the right of center on the top band in line above is the right mating H&L strip which mates to the right leg H&L strip which is positioned below attached to the right leg 38A at its stitch-line 24F on the right long foot while on the top band's far left end's top surface is the left end H&L patch 44A with its mating H&L patch 44B attached to the base band's right end's under surface.

FIG. 12 is a wide three piece band and its assembly is identical to that of FIGS. 10 and 11 and except for the addition of conventional snaps, the base band is identical to the band of FIG. 2. So to are the H&L strip, mating strip, patches. The top band is identical in length and width also with the pair of holding legs as in FIG. 2 with the exception of a left long foot and an identical right long foot which are the outer ends of the top band and the H&L strips, and patches are also the same as in FIGS. 3 and 4. Shown is the cross-center H&L pads which are cut to fit between and are attaches between the legs on the base band's top surface across center, having a matching mating H&L pad which bonds to the under surface of the phone or device and mate to the cross center H&L pad when the phone is placed between the leg's Inner wall H&L strips and the two cross-center pads come in contact with one-another.

FIG. 14-16—Alturnative Embodiments

There are many other embodiment such as one in which a top ellipse band is longer than a base band as FIG. 1 to 8 and FIG. 12. The top has when longitudinally open, three flaps cut to protrude a predetermined distance out from the top band along its one side with the uncut rectangular flap starting at an imaginary running center-line 46 and running left along the band's length to a predetermined point half the width of the device to be held. This is the left leg's top end where the protruding rectangular flap is dissected outward the flap's full width from the band's one side. The remaining material continues left a predetermined length, the thickness of the device to be held where the flap stays in place at the stitch-line and the band material turns at a right angle and extends to the base band's far left end. The flap is an extensions of the leg and the flap's bottom portion is at the leg stitch-line when the flap is folded and assembled. Therefor, from the outer end to the point short of center, where each leg and foot portions are sewn to the base or sweet pad. This procedure is repeated or mirrored to the right of the center line and is attached to the base band, creating a upside down rectangular O with a wing on each side and at one end a rectangular flap extending across center to the right and left having also an adjacent flap right and left which are folded in to meet in the center of the O closing the one end. Then bringing the rectangular cross center flap down to cover the closed left and right flaps, creating a smooth one piece closed one end and the three flaps are sewn or bonded to one-another and along their bottom to the base band.

This configuration can be achieved also with two ellipse or rectangular bands having the bottom band short and the top band predetermined longer, by placing the long band's left end on top of the short or regular base band's left end. Identical to the band in FIG. 1 to 8. With both band's left ends lined up together, place a cellular phone between the top band and the base band, on top of the base band and across the base band's width, straddle the center line, and with both the base band and the top long band running from left to right, attach them together from the left outer ends inward tight against the left side of the phone or device and across the bands width allowing the remaining band material to snugly fit over the phone's face. Then, with the top band material partly encircling the phone and again touching the base band, starting tight against the right side of the phone attaching across the bands width, then attach the top and base bands together from there to the outer ends of both bands. This creates a phone in a pouch, case, or pocket with wings. The band case face is cut to expose the phone's workings and fitted with a clear material covering. The two bands are sewn or bonded together around their perimeter and across the width at the leg stitch-line and fitted with the H&L patches of FIG. 3 having replaced the holding members, leg H&L strips, and mating strips by extending the legs over the phone's face, and by cutting and configuring the portion which covers the phone's fact to expose the phone's view screen and the dials, and then covering those open sections with conventional clear material. One has a wrist worn protective holder of cellular phones and other devices. This can also be achieved by completely encircling the phone tightly by sewing or bonding with a flexible material and bonding or sewing that material to a band such as the band of FIG. 2 with the end patches of FIG. 4 through 8 and the view screen and dials cover as in FIG. 14 to 21 and closing a one end.

FIG. 14-21—Alturnative Embodiments

Further possibilities shows a long ellipse band as described above where as the base band is replaced by a sweet pad FIG. 14-16 #2 which is sewn below the top band at the leg stitch-line FIG. 18 #12 to the left and right of center below the phone 52 and extend outward on two sides FIG. 19 #13 adjacent each end's Velcro patch stitch line and are attached across the band's mid ends width. The H&L patches are shown in FIGS. 3 and 4. The materials and attachment products suitable for use are as in the aforementioned Figs.

### ADDITIONAL ADVANTAGES

From the aforementioned descriptions, one can see a number of advantages of my universal holder for holding and carrying cellular phones and other device similar in size and shape. The coming cellular phones for the wrist are in need of easier operation and functionality but Im sure this will come, but until then the need for on the wrist worn holder is answered with my band. Those advantages offered with my band are as follows.

The ability to wear ones makeup on the wrist simply by placing the compact kit block designed as a part of this invention, example FIG. 54-1, 54-4, and being able to hold art paint brushes while painting and using the same holder to carry pens, pencils, drill bits, and any other small device similar, such as conventional devices fitting the block and cellular phones general shape. Many pager, calculators, garage door openers, auto cd, tv, or job related remotes and pagers all can be easily carried and used with ease and without loss. So far no wrist holder was found in pyre art for holding and carrying conventional cellular phones so one can see the need this band answers. The need to fasten notes, keys, lip moisturizers, and other thing to a child's collar is answered with a box block such as in the aforementioned FIG. examples 54-1, -4, knowing that any little small box similar in size and shape to the aforementioned, with a strip of H&L attached such as cough drops can be carried easily, because the band's legs can be made wide or narrow to the right and left of center, almost every thing rectangular, square, or ellipse, fairly narrow and relatively small can be held atop my band, which can be made in-expensively, quickly and versatile.

### ADDITIONAL EMBODIMENT OPERATION

In operation the additional embodiments are used and utilized in the exact manner as in operations page 1 through 34 as the entire invention and all its parts boil down to the one set of acts. Place and attach the hook and barb, mating H&L strips along the outer sides of the phone or device to be held by bonding, screwing or other attachment means, then place the phone between the standing L shaped holding member's legs and their leg Velcro strips and complete the mating of the strips by squeezing them tight against the phone and one-another which will fasten the phone to the band and the end patches will fasten the band about one's wrist.

### OPERATION

In operation my universal band is worn about a user's wrist or limb in a normal wrist watch fashion. Held in place about the wrist by two fasteners patches 22A and 22B as in FIGS. 1, 4, and 7 one at each end, left and right, male and female. Named for their look across the band's 20 end, when they are overlapping one another a tight durable coupling is complete. With the band 20 secured about a users wrist, two holding membres 26A and 28A FIG. 4 left and right are located to the left and right of center 46 FIG. 7. The holding member's upper leg 26A and 28A FIG. 2 being flexible and able to flap right and left and are positioned to hold square, oval, round or rectangle devices 54 and cellular phones 52 straddle the center line 46 across the band's 20 width. Each leg has a fastener strip 30A and 30B FIG. 7 to their inner walls. Two mating fastener strips 32A and 32B are bonded to the left and right outer sides of the cell phone 52. The fastener strips 32A and 32B mate to 34A and 34B when the phone 52 or device 54 is placed between the two sets.

Wearing my band is accomplished simply by,

(1) Place the band on top the wrist and with the free hand overlap the end fastener patches 22A and 22B securing the band to the wrist and then hold the phone 20 in the free hand.

(2) Place the phone 20 between the standing legs 26A and 28B

(3) With the thumb and for finger press the male and female fastner strips 30A and 30B and 32A and 32B together locking

(4) the phone 52 and atop the band 20.

(5) Thereby, my wide band 20 fits comfortable about the wrist.

(6) Follow the same procedure to hold other devices similar in size and shape

(7) Holds them snug and safe with the help of the end patches 22A and 22B

(8) The holding members 26A, 26B, 28A and 28B

(9) The inner leg strips 20A/30B (10) The mating strips 32A/32B shown in FIG. 2 through FIG. 8

### CONSLUSIONS, RAMAFICATIONS, AND SCOPE

No doubt one can see from the description, drawings and drawing examples, the usefulness of such an Improvement over the present holder, carriers, cases, jackets and the like on the market for cellular phones and similar devices. The L shaped holder can be used to hold and carry any thing one wants to carry which is similar in size and shape to cellular phones and that will not interfere with the wrist or the arm, and can accommodates cellular phones even when they are enclosed in most holders, cases, and jackets, merely by bonding a pair of H&L strip to the out ides of the device to be held.

The band portion can be made longer to encircle the leg or arm from the wrist to the upper arm and by placing a mating H&L strip on a auto dash the band can be secured there and any place in an auto, home, barn, belt, pant leg, and shoulder or any surface capable of holding a small mating H&L strip to which one wants to secure a phone. Unlike any prior art found, with this holder the lost phone days are gone.

It can work wonders for those with tree and post climbing jobs by holding not just phones but cable components and hardware screws, bolts and nuts for instance.

### CRAWLING

Those with crawling jobs for example, like plumbers would have hands, pocket, and waste free access to their phones while underneath a structure without dragging it off the waste or it slipping from a pocket.

Carpenters and roofers who often need screwdriver tips and communication devices would find the band useful not forgetting the mechanics who does their share of crawling repeatedly out from under a vehicle for the wrong tool, who now with a tool block, invented especially for this band configuration atop the band one can carry a choice of the tools under a job, or just a phone. Tool block shown in patent as positioning and usage examples.

People with metal buttons or snaps on a pocket where their phone is carried will have the sometimes loss of cell phone reception problem virtually solved.

In conclusion, with the present band and its blocks and a pocket full of H&L strips, one could hold and carry numerous small items and small devices of similar size and shape as a conventional cellular phone. Many other variations are possible such as one in which the band and legs are one mold. Therefor one can see the scope of my invention by the drawings, description, operation and conclusions.

1. I claim a universal wrist worn holder for cellular phones comprising a plurality of flexible materials configured to form support members of substantial length, width, and height having grasping and holding and means inside the upper portion with the lower portion attached across the width atop a wrist band with a second means grasping and holding.
